(19) United States
(12) Patent Application Publication
(10) Pub. No.: US 2006/0208043 A1
(43) Pub. Date: Sep. 21, 2006

(54) Carrier system

(75) Inventor: Christine Plantan, Wayzata, MN (US)

Correspondence Address: ALTERA LAW GROUP, LLC, 6500 CITY WEST PARKWAY, SUITE 100, MINNEAPOLIS, MN, 55344-7704, US

(73) Assignee: russell+hazel, Minneapolis, MN (US)

(21) Appl. No.: 11/358,584

(22) Filed: Feb. 21, 2006

Related U.S. Application Data
(60) Provisional application No. 60/655,484, filed on Feb. 23, 2005.

(51) Int. Cl. B65D 27/00; B42D 3/00; B42D 7/00

(52) U.S. Cl. 229/67.1; 281/29; 281/45

(57) ABSTRACT

A carrier system for transport of folders, binder and the like is disclosed. One embodiment includes a soft web which encompasses the binder/folder and has attachment handles which allows the binder/folder to be transported without integral handles. In another embodiment a substantially rigid material defines a pocket to receive a folder/binder. In a further embodiment the folder/binder is outfitted which attachment points for receiving removable handles.

### CROSS-REFERENCE TO RELATED APPLICATION

The present application claims the benefit of U.S. Provisional Application Ser. No. 60/655484 filed on 23 Feb. 2005, the complete subject matter of which is hereby incorporated herein by reference in its entirety.

### STATEMENT REGARDING FEDERALLY SPONSORED RESEARCH OR DEVELOPMENT

Not Applicable

### BACKGROUND OF THE INVENTION

1.Field of the Invention

The present invention is directed to a carrier system of particular advantage for office files, binders, folders or the like.

2. Background

In an office setting, containers for documents are relatively common, including file folders, expandable folders, ring binders, and so forth. Papers and other documents are routinely stored in these containers. For instance, a set of receipts may be stored in an expandable folder, such as a so-called “accordion” folder that has expandable pleats on its sides and bottom. The accordion folder may have indexable sections for various categories, such as the letters of the alphabet or month of the year. This type of folder may be a common choice when storing documents for tax preparation, because receipts for various different items may be placed into different sections in the accordion folder. As a storage device, the folder functions nicely.

However, when the time comes to transport the accordion folder and its contents to the accountant for tax preparation, the common accordion folder has some shortcomings. For instance, the folder must be held upright during transport. When holding the folder along with other items, extra care has to be devoted to maintaining the upright orientation of the folder when opening doors, pushing buttons in an elevator, and so forth. In addition to the problem that items may fall out of the folder if not carried upright, it would be convenient if a user could carry a multiplicity of folders and binders with a carrying system that hardly takes up any space when not in use. Such a system could be “at the ready” but otherwise unobtrusive. Typically such folders do not have handles and if they did, there would always be a chance of them tearing out. In addition, if the folders were outfitted with handles, they would become bulkier and fewer such folders could be fitted side by side on a shelf or the like.

Accordingly, there exists a need for a document container system that is easily transportable, compact, takes up little space and if possible attractive.

### BRIEF SUMMARY

The following is a summary of some of the features of the invention. It is not intended to define the invention, but only assist the reader when reading the entire application to get a quick overview of the subject matter. The scope of the invention is defined by the claims and the detailed description provides various embodiments. Reference should be had to those sections for a complete understanding of the invention.

According to one aspect of the invention there is shown a carrier system having a carrier folder having a pair of opposing sidewalls, defining a space for articles therebetween, each of said sidewalls have an upper edge; affixation points on proximate said upper edge of said sidewalls; at least one handle strap removably attachable to said affixation point; so that said folder can be carried by said strap when in a transport mode and wherein said straps may be removed in a non-transport mode.

According to another aspect of the invention there is disclosed a carrier system having a carrier shell having opposing sidewalls and a bottom, thereby defining a space for receiving a folder; a multi-compartment index folder having a plurality of compartments, sized to be received within said defined space, releasable attachment elements for removable affixing said folder into said shell; affixation points on said sidewalls; at least one handle strap removably attachable to said affixation points, so that said folder can be carried by said strap when in a transport mode and wherein said straps may be removed in a non-transport mode.

According to another aspect of the invention, there is disclosed a carrier system having a pliable web carrier shell capable of forming opposing sidewall portions and a bottom portion, thereby defining a space for receiving a folder sized to be received within said defined space, affixation points on said sidewall portions; at least one handle strap removably attachable to said affixation points; so that said folder can be carried by said web.

### BRIEF DESCRIPTION OF THE SEVERAL VIEWS OF THE DRAWINGS

FIG. 1 is a perspective view of an accordion folder according to one embodiment.

FIG. 2 is a perspective view of an alternate embodiment of the carrier.

FIG. 3 is a perspective view of the embodiment of FIG. 2 with handles removed;

FIG. 4 is a perspective view of a further alternate embodiment of a binder carrier system.

### DETAILED DESCRIPTION OF THE INVENTION

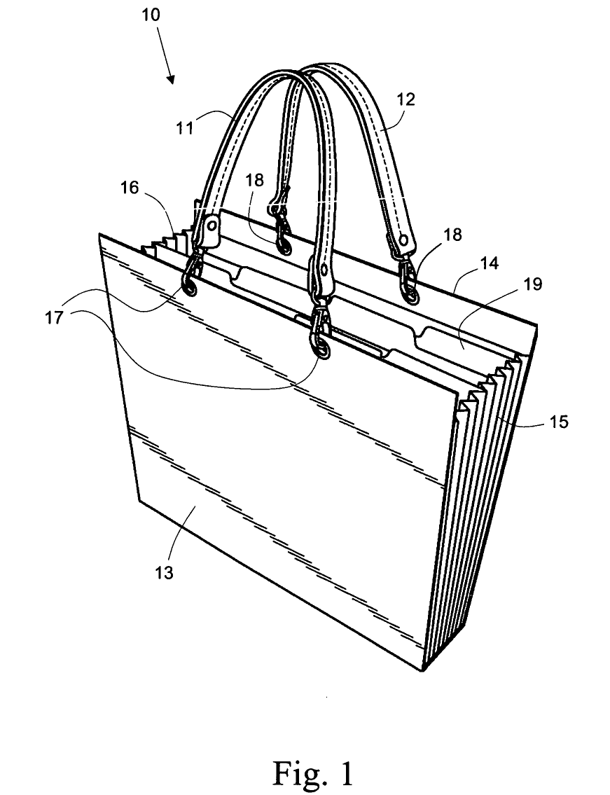

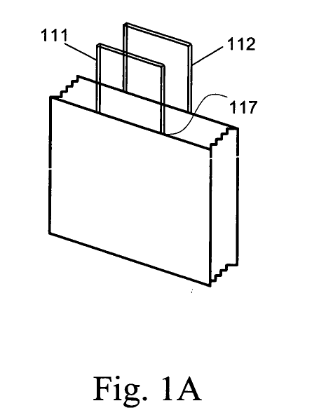

FIG. 1 shows one embodiment of the carrier system invention used on a multi-compartment index folder, in this case an accordion folder 10 with handles 11 and 12 attached to its front cover/sidewall 13 and rear cover/sidewall 14, respectively. These sidewalls are preferably substantially rigid in order to keep their form when in transport mode. It is to be understood that the accordion type file is an example, but that binders and folders of virtually any type could be substituted and still benefit from the carrier system provided thereon. The handles 11 and 12 are preferably attached through affixation points, in this case holes 17 and 18 at the top of the front and back covers, respectively, so that they may freely drop to the sides of the folder when not being held.

An alternative construction involves the use of a folder insert which comprises sidewalls 15 and dividers 19, and wherein the insert also has its own sidewalls which mate with covers 13 and 14. In effect, covers 13 and 14 and a connecting bottom (preferably rigid) form a shell into which a multi-compartment index folder can be placed within and thus transported. The multi-compartment index folder can be temporarily affixed to the carrier shell (13-14 and bottom) by Velcro®, friction, tape, magnets or any other removable affixation means. In this system, one carrier shell can be used with a plurality of multi-compartment index folder inserts.

This structure has the advantage that the handles are completely removable and when removed, the surfaces to which they are attached are made as unobtrusive as possible so that such folders can be stacked side-by-side or otherwise. This is accomplished by providing attachment means on the sidewalls which are substantially flush when the handles are removed. In this case holes are shown, but other systems, such as snaps, or other clasps, perhaps recessed, can be used.

Alternatively, other appropriate fastening methods may be used, or the handles may be integrated into the front and rear covers and be folded out of the way. For example, in FIG. 1A, a binder or folder could be made of a laminate or plastic material with the handle material being an extension of the cover material (i.e. die cut with handles) or with a handled glued or welded on, but preferably being flat/planar and having a fold line 117 where the handle can be folded away toward the inside cover of the binder. Alternatively, the 111-112 can be pushed into a receiving pocket in the sidewalls of the file so that they disappear but are always available.

The accordion folder 10 has pleated sides 15 and 16 connecting the front cover 13 and rear cover 14, and, optionally, a pleated bottom. Preferably, the accordion folder 10 has dividers 19 that can separate the contents of the folder into various compartments, which simplifies locating the stored documents. The carrier system of FIG. 1 is more convenient than a typical accordion folder, in that attachment of the removable handles 11 make the system function like a brief case or hand bag. Furthermore, panels 13 can be ornamented, as in a handbag, with a well-known trademarked pattern or other surface ornamentation. It could even be fabric-covered and appear as part of a coordinated clothing outfit.

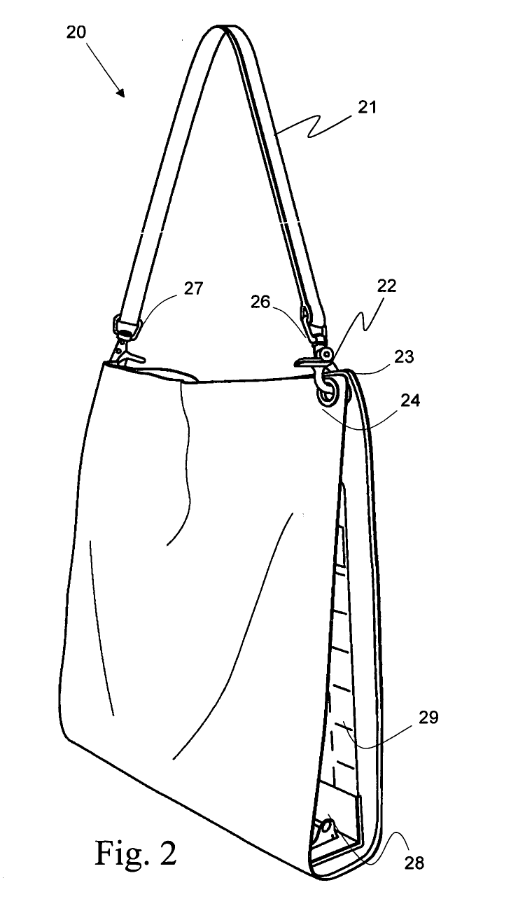

FIG. 2 illustrates an alternate embodiment of the carrier system based on the principle that existing binder/folder/file stocks cannot be easily retrofitted to receive carry straps, but can still take advantage of the present inventive concept. FIG. 2 shows a ring binder 29 with a strap handle 21. The handle 21 is removably attached to holes 22 and 23 along the top of the outside cover 24, made preferably of a soft web, such as a fabric, by adjustable swivel clasps 26 and 27. When the clasps 26 and 27 are engaged, the binder 20 may be supported by the handle 21. Inside the binder 20 is a ring binder mechanism 28 (for illustration only, since almost any item can be carried in this system), and an optional internal cover 29 that protects any documents stored in the binder. The internal cover 29 may be attached to the outside cover 24 by a suitable manner, such as Velcro®, or may be unattached to the outside cover 24. Gussets could be provided (not shown) which span the two sides of panels 24, perhaps just a minor portion of the distance from the bottom toward the top (such as 25%-33%) or all the way to the top, though this will impede the expandability of the space between the panels 24.

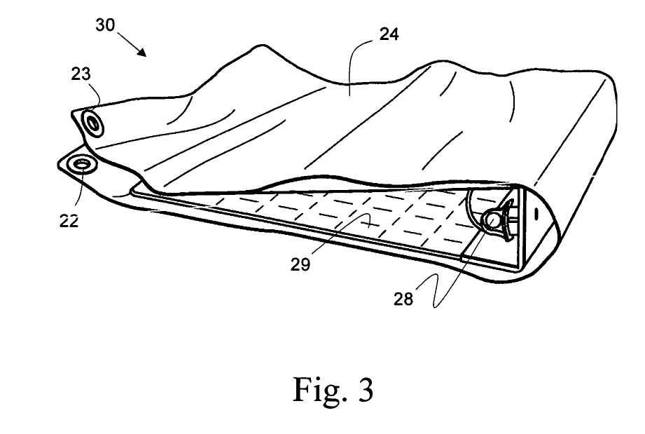

The system of FIGS. 2 and 3 illustrate a soft cover system. The cover 24 is preferably a web, which is defined as a pliable material capable of generally conforming to the shape of the object carried therewithin.

The overall length of panel 24 is determined by how many binder-like items are to be carried therebetween. Double handles can also be provided as is shown in FIG. 1, but for this embodiment, a single handle is used.

FIG. 3 shows the carrier system of FIG. 2 with the handle removed. The outside cover 24, no longer joined at holes 22 and 23, is free to be opened by the user, allowing access to the internal cover 29, the ring binder mechanism 28, and any documents stored in the binder 30. Note, that the carrier may now be rolled up, or otherwise made into a deminimus package, for later use.

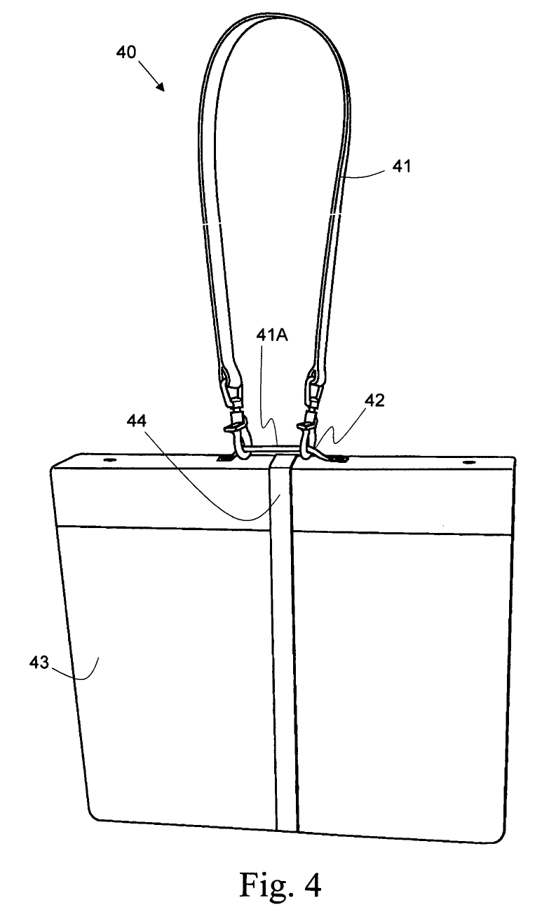

FIG. 4 shows a carrier system 40 with a shoulder strap 41. The strap 41 is connected to an intermediate handle 42, which in turn is attached to the cover 43. Alternatively, each end of the shoulder strap 41 may be attached to its own intermediate handle 41A, or may be attached directly to the cover 43 by various means, such as double adjacent holds, studs with loops, etc. Inside the cover 43 can be, for example a ring mechanism, located at the end nearest the strap 41, so that when the binder 40 is suspended by the strap 41, the contents of the binder 40 are suspended by their holes. There is a securing strap, preferably a rubber band type binder 44 around the outside of the cover 43, which ensures that the binder 40 remains closed during transport. The securing strap 44 may alternatively have a buckle, snap, hooked fastener, or other suitable locking mechanism to secure the binder. Alternatively, the securing strap may be replaced by an extension on one or both ends of the cover, which folds over the contents and is secured on the opposite end of the cover. This structure works best on ring binders since the open end of the binder is facing the ground when carried and it is important that there are other means to keep articles from calling out. A binder with a cover flap would be a suitable solution.

The advantage of the structure in FIG. 4 is that awkward binders can be carried with the minimum of modification. In fact, the handle/strap 41a can provide a convenient way to withdraw the binder from a shelf by inserting one's finder into the gap between the binder and the strap.

Although the various embodiments shown in FIGS. 1-4 are for ring binders or accordion folders, it will be understood to one of ordinary skill in the art that other types of document containers may be used as well. The functional advantage of the carrier system is created by making binders/folders/files/etc, which were previously hard to carry, now convertible into briefcases or handbags and without modifying the function of same and without requiring a bulky mechanism. The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A carrier system comprising:
a.) A carrier folder having a pair of opposing sidewalls, defining a space for articles therebetween, each of said sidewalls have an upper edge;
b.) affixation points on proximate said upper edge of said sidewalls;
c.) at least one handle strap removabiy attachable to said affixation point;
so that said folder can be carried by said strap when in a transport mode and wherein said straps may be removed in a non-transport mode.

2. The system of claim 1 wherein said affixation points are apertures in said sidewall portions.

3. The system of claim 2 wherein said straps engage said apertures.

4. A carrier system comprising:
b) a carrier shell having opposing sidewalls and a bottom, thereby defining a space for receiving a folder;
c) multi-compartment index folder having a plurality of compartments, sized to be received within said defined space,
d) releasable attachment elements for removable affixing said folder into said shell;
e) affixation points on said sidewalls;
f) at least one handle attachable to said affixation points;
so that said folder can be carried by said strap when in a transport mode and wherein said straps may be removed in a non-transport mode.

5. The system of claim 4 wherein said at least one handle is retractable within said shell.

6. The system of claim 4 wherein said affixation points are apertures in said sidewall portions.

7. The system of claim 6 wherein said sidewall portions have top edges and wherein said affixation points are proximate said edges.

8. The system of claim 7 wherein said straps engage said apertures.

9. A carrier system comprising:
b) a pliable web carrier shell capable of forming opposing sidewall portions and a bottom portion, thereby defining a space for receiving a folder sized to be received within said defined space,
c) affixation points on said sidewall portions;
d) at least one handle strap removably attachable to said affixation points;
so that said folder can be carried by said web.

10. The system of claim 9 wherein said affixation points are apertures in said sidewall portions.

11. The system of claim 10 wherein said sidewall portions have top edges and wherein said affixation points are proximate said edges.

12. The system of claim 11 wherein said straps engage said apertures.
